(19) United States
(12) Patent Application Publication
(10) Pub. No.: US 2006/0268931 A1
(43) Pub. Date: Nov. 30, 2006

(54) Method, device and computer readable medium for exchanging information in a hybrid environment

(76) Inventor: Assaf Sella, Rishpon (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/142,208

(22) Filed: May 31, 2005

(51) Int. Cl. H04J 3/16

(52) U.S. Cl. 370/468

(57) ABSTRACT

A device, method and a computer readable medium having code embodied therein for causing an electronic device to perform multiple stages. The method includes: (i) utilizing a distributed media access control scheme for allocating at least one time slot for exchanging information between a hybrid ultra wide band device and multiple access controlled devices; (ii) allocating, by the hybrid ultra wide band device, multiple mini-time slots within the at least one time slot, for exchanging information between the hybrid ultra wide band device and the multiple access controlled devices; and (iii) generating distributed media access controller events in response to the allocation. A hybrid ultra wide band device that includes: (i) a distributed medium access controller adapted to participate in a distributed media access control scheme that allocates at least one time slot for exchanging information between a hybrid ultra wide band device and multiple access controlled devices; and (ii) a timing component, connected to the distributed media access component, adapted to allocate multiple mini-time slots within the at least one time slot, for exchanging information between the hybrid ultra wide band device and the multiple access controlled devices and to participate in a generation of distributed media access controller events in response to the allocation.

### FIELD OF THE INVENTION

The invention relates to methods, devices and computer readable mediums for exchanging information in a hybrid ultra wide band environment.

### BACKGROUND OF THE INVENTION

Recent developments in telecommunication and semiconductor technologies facilitate the transfer of growing amounts of information over wireless networks.

The demand for short to medium range, high speed connectivity for multiple digital devices in a local environment continues to rise sharply. For example, many workplaces and households today have many digital computing or entertainment devices such as desktop and laptop computers, television sets and other audio and video devices, DVD players, cameras, camcorders, projectors, handhelds, and others. Multiple computers and television sets, for instance, have become common in American households. In addition, the need for high speed connectivity with respect to such devices is becoming more and more important. These trends will inevitably increase even in the near future.

As the demand for high speed connectivity increases along with the number of digital devices in typical households and workplaces, the demand for wireless connectivity naturally grows commensurately. High-speed wiring running to many devices can be expensive, awkward, impractical and inconvenient. High speed wireless connectivity, on the other hand, offers many practical and aesthetic advantages, which accounts the great and increasing demand for it. Ideally, wireless connectivity in a local environment should provide high reliability, low cost, low interference caused by physical barriers such as walls or by co-existing wireless signals, security, and high speed data transfer for multiple digital devices. Existing narrowband wireless connectivity techniques do not provide such a solution, having problems such as high cost, unsatisfactory data transfer rates, unsatisfactory freedom from signal and obstacle related interference, unsatisfactory security, and other shortcomings. In fact, the state of the art does not provide a sufficiently satisfactory solution for providing high speed wireless connectivity for multiple digital devices in a local environment.

Some of short-range ultra wide band wireless networks are characterized by a distributed architecture in which devices exchange information without being controlled by a central host or a base station. The MBOA (Multi Band OFDM Alliance) include multiple vendors that defined a PHY ultra wide band layer and a distributed MBOA MAC layer. FIG. 1 illustrates an MBOA network 10 that includes three devices—device A 11, device B 12 and device C 13. These devices use an MBOA MAC scheme to coordinate the access to the wireless medium that they share.

Some of the short-range ultra wide band wireless networks use a centralized media access control scheme. The access to the shared wireless medium is determined by a host device that transmits media access control information to the other devices.

Multiple vendors are promoting a Wireless Universal Serial Bus (WUSB) standard. This standard suggests to define a wireless system that includes a single USB host and multiple wireless USB devices. The access to the shared wireless medium is determined by the wireless USB host. FIG. 1 also describes a WUSB network 20 that includes wireless USB devices—device E 25, device F 26 and devices G 24, as well as a wireless USB host that is device B 12.

The WUSB standard defines MAC super frames that include two hundred and fifty six media access slots (MAS), each being two hundred and fifty six microseconds long. Each slot includes multiple mini-slots. These mini-slots are also referred to as channel-time-allocation (CTA).

The wireless USB host determines the access to the medium shared by it and the wireless USB devices within its group (or cluster) on a mini-slot basis. The allocation involves transmitting an Micro Scheduled Management Command (MMC) frame that determines the access to the wireless medium during multiple mini-slots within a WUSB DRP reservation.

FIG. 2 illustrates a super frame 30 that includes multiple beacon slots 31, multiple MBOA DRP or MBOA PCA slots (denoted DRP/PCA) that are not allocated for WUSB transmission, and two DRP WUSB slots 32 and 34. The two DRP UWSB slots are dedicated to WUSB transmission. The first DRP WUSB slot 32 includes two MMC frames 40 and 44 and two sequences of reception and transmission mini-slots 42 and 46. The second DRP WUSB slot 34 includes three MMC frames 50, 52 and 54 and three sequences of reception and transmission mini-slots 51, 53 and 55.

There is a need to provide efficient methods, devices and computer readable medium for exchanging information in a hybrid ultra wide environment.

### SUMMARY OF THE INVENTION

A method for transmitting information, the method includes: (i) utilizing a distributed media access control scheme for allocating at least one time slot for exchanging information between a hybrid ultra wide band device and multiple access controlled devices; (ii) allocating, by the hybrid ultra wide band device, multiple mini-time slots within the at least one time slot, for exchanging information between the hybrid ultra wide band device and the multiple access controlled devices; and (iii) generating distributed media access controller events in response to the allocation.

A hybrid ultra wide band device that includes: (i) a distributed medium access controller adapted to participate in a distributed media access control scheme that allocates at least one time slot for exchanging information between a hybrid ultra wide band device and multiple access controlled devices; and (ii) a second component, connected to the distributed media access component, adapted to allocate multiple mini-time slots within the at least one time slot, for exchanging information between the hybrid ultra wide band device and the multiple access controlled devices and to participate in a generation of distributed media access controller events in response to the allocation.

An access controlled device that includes: a media access unit, adapted to time reception and transmission of information; a second component, connected to the timing unit, adapted to receive timing information transmitted by a hybrid media access device; and to generate media access unit timing events in response to the timing information and to at least one delay associated with a reception of the timing information.

A computer readable medium having code embodied therein for causing an electronic device to perform the stages of: (i) utilizing a distributed media access control scheme for allocating at least one time slot for exchanging information between a hybrid ultra wide band device and multiple access controlled devices; (ii) allocating, by the hybrid ultra wide band device, multiple mini-time slots within the at least one time slot, for exchanging information between the hybrid ultra wide band device and the multiple access controlled devices; and (iii) generating distributed media access controller events in response to the allocation.

### BRIEF DESCRIPTION OF THE DRAWINGS

The present invention will be understood and appreciated more fully from the following detailed description taken in conjunction with the drawings in which:

FIG. 1 illustrates an MBOA network and a WUSB network;

FIG. 2 illustrates a super frame;

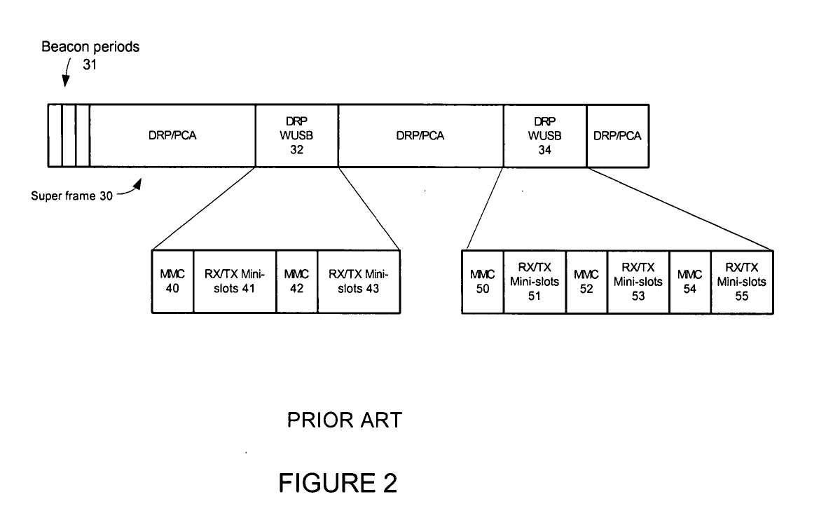

FIG. 3 illustrates an MMC frame

FIG. 4 illustrates a hybrid ultra wide band device, according to an embodiment of the invention;

FIG. 5 illustrates an access controlled device, according to an embodiment of the invention; and

FIG. 6 is a flow chart of a method for transmitting information, according to an embodiment of the invention.

### DETAILED DESCRIPTION OF THE DRAWINGS

For convenience of explanation it is assumed that the distributed media access control scheme is an MBOA MAC compliant scheme and that the centralized MAC scheme is a WUSB MAC compliant scheme. It is noted that according to various embodiments of the invention the described devices and methods can be applied to other distributed and centralized MAC schemes.

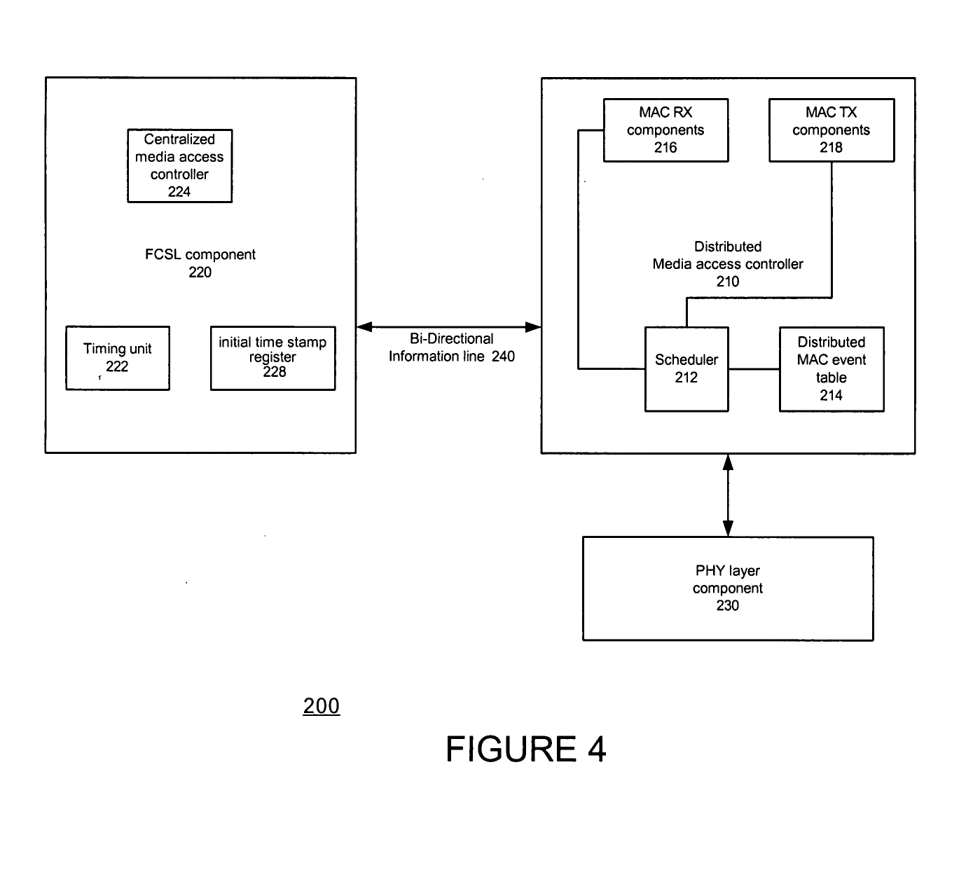

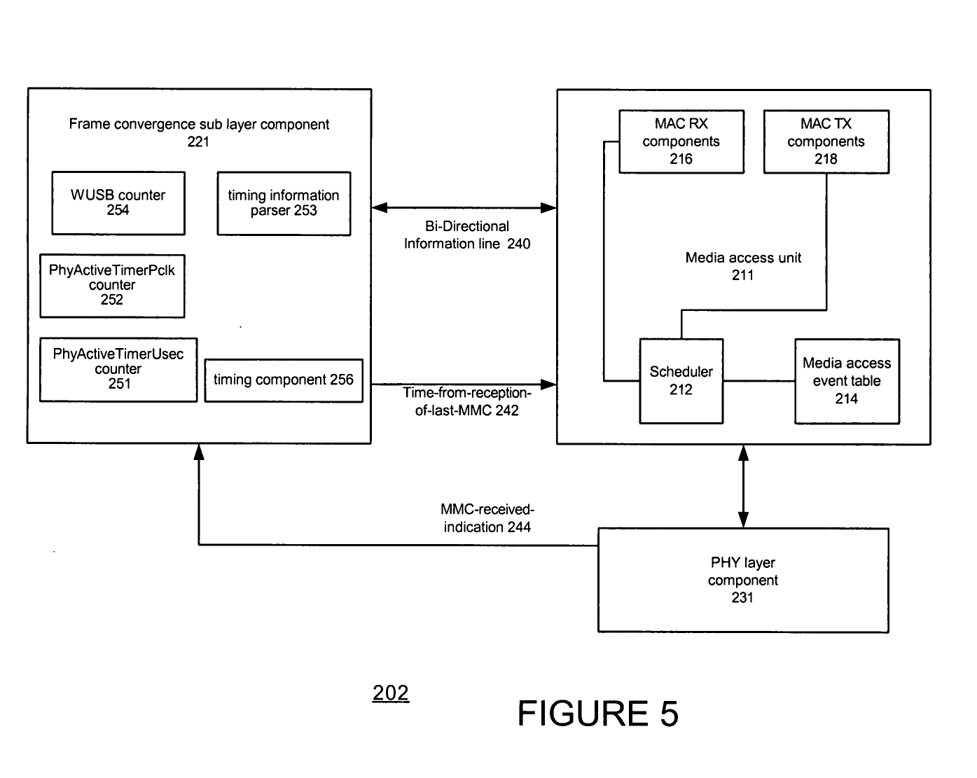

For convenience of explanation FIGS. 4 and 5 illustrates devices that have only one PHY layer component, one MAC layer component and one FSCL layer component. It is noted that usually each of these components represent multiple software and hardware components and that some components can service more than a single layer. It is further noted that the EFCSL layer component can be replaced by another component that applies operations of another layer. It is further noted that various other components were omitted for simplicity of explanation. These omitted components can include application PHY and MAC layer components, and various layer management entities.

FIG. 4 illustrates a hybrid ultra wide band device 200, according to an embodiment of the invention.

The hybrid ultra wide band device 200 is adapted to participate in a distributed media access control scheme and is also adapted to control the access of access controlled media access devices to a shared wireless medium. The term hybrid refers to the capability of device 200 to participate in both types of media access control schemes. In a sense device 200 can be viewed as a dual purpose device.

Conveniently, the development and design of device 200 can be simplified by using an existing MBOA MAC component, such as distributed media access controller 210, and feeding the distributed media access controller 210 with WUSB events.

MBOA media access controllers are known in the art and can have various configurations. For example, Wisair Ltd. of Tel Aviv, Israel manufactures MBOA MAC layer chips. The inventors used a MBOA media access controller of Wipro, India, but other MBOA media access controllers can be used.

In general, a distributed media access controller 210 includes a MAC receive path components (“RX MAC components”) 216, MAC transmit path components (“TX MAC components”) 218, a scheduler 212 and a distributed media access controller event table 214 for triggering distributed media access controller events. The events can include transmitting information, receiving information, and the like.

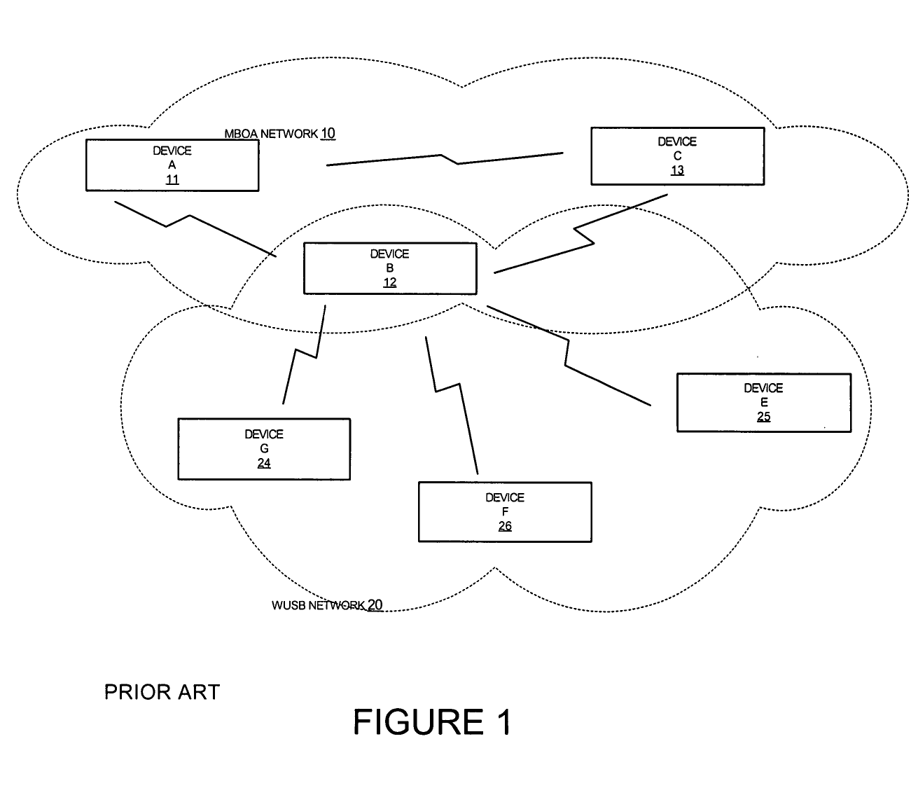

The distributed media access controller 210 is adapted to participate in a distributed media access control scheme that allocates at least one time slot for exchanging information between a hybrid ultra wide band device and multiple access controlled devices. Referring to the example set forth in FIG. 1, device 200 can replace device B 12 and participate in a MBOA MAC scheme (along with device A 11 and device C 13) in order to allocate at least one time slot (like DRP WUSB time slots 32 and 34) for exchanging information with devices E-G 25, 26 and 24.

The hybrid ultra wide band device 200 also includes a PHY layer component 230 and a second component such as an embedded frame convergence sub layer (EFCSL) component 220. The EFCSL component 220 conveniently includes a centralized media access controller 224 and a timing unit 222. The EFCSL component 220 is connected to the distributed media access controller 210 and is capable of allocating multiple mini-time slots within the at least one time slot, for exchanging information between the hybrid ultra wide band device 200 and the multiple access controlled devices. The at least one time slot is conveniently a DRP type slot.

The EFCSL component 220 is further adapted to participate in a generation of distributed media access controller events in response to the allocation.

Conveniently, the MBOA network utilizes a MBOA clock that differs from a WUSB clock that is being used by WUSB network. One of the functions of the timing unit 222 is to translate between WUSB clock values (that are associated with the WUSB events) and between the MBOA clock values, as the distributed media access controller 210 receives an MBOA clock.

The timing unit 222 is capable of sampling both clock values for adjusting the timing information that is sent to the distributed media access controller 210 accordingly.

According to an embodiment of the invention the software portion of the EFCSL component 220 generates MMC frames in which it determines the access to the wireless medium during a WUSB time slot. The MMC includes timing information associated with the exchange of information between the hybrid ultra wide band device and one or multiple access controlled devices. Conveniently, each WUSB event is associated with a start time, duration and type of event (reception, transmission).

Each MMC frame includes a MMC time stamp (also referred to as hybrid device time stamp) representing the beginning of a transmission of the MMC frame. It is noted that other timing reference points can be selected.

Conveniently, each MMC frame also includes a time difference between multiple time slots allocated for exchanging information between a hybrid ultra wide band device and multiple access controlled devices. Conveniently the time difference represents the difference between two consecutive MMC frames.

It is noted that the hybrid ultra wide band device 200 can exchange timing information and additional MAC related information in other manners without departing from the scope of the invention.

This time difference is processed by a media access control device in order to determine when to initiate a reception window, in order to receive the next MMC. Conveniently the access controlled devices do not participate in the MBOA network transmissions, thus they relay upon the time difference information in order to open the reception window.

The centralized media access controller 224 can allocate mini-time slots by applying various well known media access control schemes. Some of these media access control schemes are illustrated in the Wireless Universal Serial Bus Specification, Revision 1.0, which is incorporated herein by reference.

FIG. 5 illustrates an access controlled device 202, according to an embodiment of the invention.

The access controlled device 202 includes a PHY layer component 231, a second component such as a frame convergence sub layer (EFCSL) component 221 and a media access unit 211.

According to an embodiment of the invention the access control device 202 can be substantially the same as the hybrid ultra wide band device 200. In such a case it can utilize a distributed media access controller to initiate centralized media access events. In such a case components 211, 221 and 231 can be substantially the same as components 210, 220 and 230.

The difference between device 200 and device 202 can result from different configurations of these devices—one being configured to act as a wireless USB host while the other is configured to act as a wireless USB device. The configuration can be fixed but can also change over time.

It is further noted that even if device 200 differs from device 202 they can have at least one substantially identical component, such as the same PHY layer component 230.

The EFCSL component 221 conveniently includes a timing component 256 that is adapted to receive timing information transmitted by the hybrid ultra wide band device 200 and to generate timing unit events in response to the timing information and to at least one delay associated with a reception of the timing information.

The media access unit 211 is adapted to time reception and transmission of information, in response to media access control information such as timing information included within an MMC frame. The inventors used a MBOA MAC of Wipro as a media access unit 211, but other media access unit, and especially much simpler media access units can be used.

Simpler media access units can be used if they are not required to participate in MBOA media access control schemes, and if they are not required to control the centralized media access control scheme.

The access controlled device 202 is adapted to define a reception window in response to a received time difference between MMC frames. If consecutive MMC frames are transmitted during different time slots then the time difference is responsive to a time difference between MBOA time slots allocated for exchanging information between the hybrid ultra wide band device and the multiple access controlled devices.

Conveniently, the access controlled device 202 is adapted to define a reception window in response to a relationship between time lapsed from a last time slot during which the access controlled device exchanged information with the hybrid ultra wide band device and between a time threshold. For example, if device 202 does not receive a certain MMC, it will open a reception window when a timer that counts time that passed from the reception of the last MMC (that was previously received by device 202) is equal or larger than threshold value, such as NextMmcTime.

FIG. 5 illustrates that the FSCL component 221 and the media access unit 211 are connected via a bi-directional information line 240, and an additional line that conveys a Time-from-reception-of-last-MMC signal 242.

The PHY component 231 can provide to the EFCSL component 221 an MMC-received indication signal 244.

The PHY component 231 provides the media access unit 211 signals representative of the radio frequency signals it receives. These signals are provided, by the media access unit 211, over line 240, to the FSCL component 221.

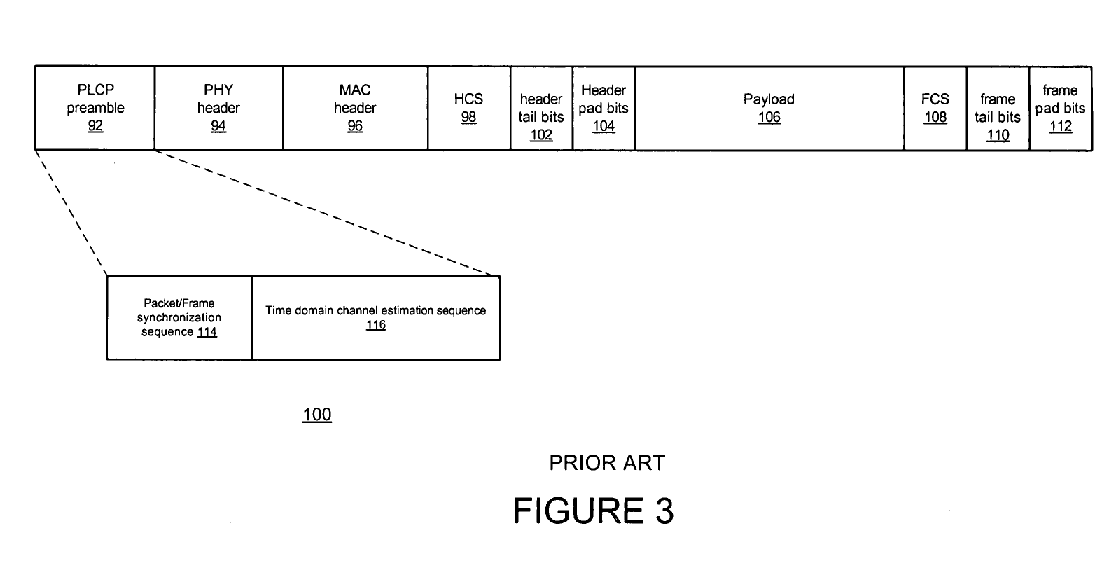

In addition, the EFCSL component 230 analyses various layer fields, such as the PLCP header 92, in order to detect an MMC frame, such as MMC frame 100 of FIG. 3.

MMC frame 100 includes a physical layer convergence procedure (PLCP) preamble 92, a PHY layer header 94, a MAC layer header 96, a header check sequence field (HCS) 98, header tail bits 102, header pad bits 104, payload 106, a frame check sequence field (FCS) 108, frame tail bits 110 and pad bits 110. Accordingly, the information frame 100 includes MAC layer fields and various PHY layer fields. The payload 106 may include a MMC frame.

It is noted that the structure of information frame 100 is dictated by certain PHY layer and MAC layer requirements. It is assumed that the information frame 100 is MBOA compliant. It is noted that other formats can be used, in response to the utilized MAC and PHY layers.

Conveniently, device 202 defines the first frame that it received after the start of a reception frame as an MMC frame. It is noted that the definition can also be responsive to the content of the received frame.

The MMC frame includes an MMC time stamp that represents the beginning of a transmission of the MMC frame. It is noted that multiple delay periods are associated with various stages of the MMC frame transmission, PHY component 231 reception, PHY component 231 analysis and EFCSL component 221 reception of the MMC frame.

A transmission delay over the wireless medium is either non-significant or is estimated during tuning sessions. The tuning session are usually performed in order to allow proper reception and transmission of various types of frames between various devices.

The delay between the beginning of the MMC frame and the detection of the MMC frame is responsive to a frame processing latency (denoted PhySyncDelayPclk) and to the length of packet/frame synchronization sequence 114 (denoted TimePreambleDurationPclk). The frame processing latency represents the period that is required to detect a reception of a frame once the packet/frame synchronization sequence 114 ended. It is assumed that the PHY component 231 detects that it received an information frame at the end of said sequence 114. This delay can be estimated based upon the performance/structure of the PHY component and in response to the predefined length of the packet/frame synchronization sequence 114.

Once the PHY component detected the MMC frame it asserts a MMC-received-indication signal 244. Two timers denoted PhyActiveTimerUsec 251 and PhyActiveTimerPclk 252 start counting once signal 244 is received by the EFCSL component 221. These counters are used to count the delay between the detection of the MMC frame and the reception of that frame by the EFCSL component 221. The string “Pclk” denotes PHY layer clock period value, while the string “Usec” represents a value in microseconds.

Both counters PhyActiveTimerUsec 251 and PhyActiveTimerPclk 252 are eight bit long. Counter 251 counts the delay in units of microsecond. Counter 252 provides the Pclk resolution. These counters can be fed by a fast PHY layer clock that has a frequency that exceeds 1 MHz. Counter 251 can be clocked by a one microsecond clock signal that is generated by resetting a counter whenever a predefined number of PHY layer clock cycles passes. The inventors used a 66 Mhz PHY layer clock and the microsecond clock signal was generated every sixty six PHY layer clock cycles. Counters 251 and 252 provide a PhyActiveTimer value.

When the EFCSL component 211 receives the MMC frame it extracts (by timing information parser 253) the MMC time stamp (denoted MMCTimeStamp) and updates its WUSB clock value (denoted WusbTime) accordingly:
WusbTime=MMCTimeStamp+PhyActiveTimer+PhySyncDelayPclk+TimePreambleDurationPclk.

Conveniently this calculation is done in the time resolution of the PHY clock signal, thus it may require various value translations. The inventors used a MMC time stamp of twenty four bits wherein the most significant seventeen bits counts the time stamp in 125microsecond units. Conveniently, the WusbTime is thirty eight bits long.

Conveniently, a WUSB counter 254 is updated by WusbTime once the MMC frame was received and processed by the EFCSL component 221. After the WUSB counter is updated it continues to be count PHY clock cycles.

A timing component 256 is updated by the value of (PhyActiveTimer+PhySyncDelayPclk+TimePreambleDurationPclk) once the WUSB counter 254 is updated. This timing component 256 is adapted to: (i) count the time lapsed from the reception of the last MMC frame, (ii) provide a media access unit 21 compatible count value that is referred to as Time-From-reception-of-last MMC 242. The latter count value is compared, by the scheduler 212, to time associated with events that are previously written in the media access event table 214.

According to an embodiment of the invention the timing component 256 stops counting when it reaches a predefined timing value such as 0×FFFF.

Assuming that the media access event table 214 includes a MMC reception event that is associated with an expected value then device 202 should open a reception window when the counter reaches the expected value.

According to another embodiment of the invention the access controlled device 202 is capable of receiving MBOA transmissions (such as hybrid ultra wide band device 200). In such a case it can be aware of the allocated WUSB DRP slots and re-open its received whenever such as time slot arrives, especially if the timing components reaches the predefined timing value.

Various events in the media access event table 214 are written by the EFCSL component 221, in response to MMC information (including timing information) that is included within the MMC frame. An event is usually characterized by its start time (from the reception of the last MMC), its duration and its type. The media access unit 211 compares the Time-From-reception-of-last MMC signal 242 to the values of the table in order to determine when to initiate an event.

Conveniently, the first event includes opening a receiver in order to receive an MMC frame.

Referring now to FIG. 4. Device 200 includes a WUSB counter for maintaining WusbTime. This counter is clocked by a PHY layer clock signal. It also can include a WUSB counter for maintaining the that clock.

The EFCSL component 220, and especially an EFCSL software component within the EFCSL component 220, can read the values of the various clocks by using dedicated registers.

The EFCSL component 220 includes an initial time stamp register 228. This register stores an initial MMC time stamp (referred to as InitTimeStamp) that is used when the system is initialized.

Once the device 200 is initialized, and before the first MMC is transmitted, the EFCSL component 220 reads the value of WusbTime, write this value to the initial time stamp register 228 and sets the time from the last MMC to: TimeFromLastMmcUsec=WusbTime−InitTimeStamp.

In addition the EFCSL component 220 writes to the distributed media access control event table 214 a first event of starting to transmit an MMC at start time of InitTimeToMMC. This initialization time is calculated in response to the initial time stamp and is expressed in WUSB clock units.

It is noted that the MMC includes timing information relating to transmission events to take place during a sequence of mini-time slots. In addition the MMC includes a time difference between multiple time slots allocated for exchanging information between a hybrid ultra wide band device and multiple access controlled devices. Conveniently a single value representing the time difference between consecutive time slots is provided.

The EFCSL component 220 calculates this time difference in response to the allocation of WUSB DRP slots and takes into account the drift between the MBOA clock and the WUSB clock. The time drift is calculated by periodic simultaneous reading of both clocks, calculating the drift and inserting guard intervals that ensure that the MMC falls into the MBOA DRP boundaries.

Conveniently, the last event included within the MMC is an event that requires to open a reception window after the time difference between MMC transmission events ends.

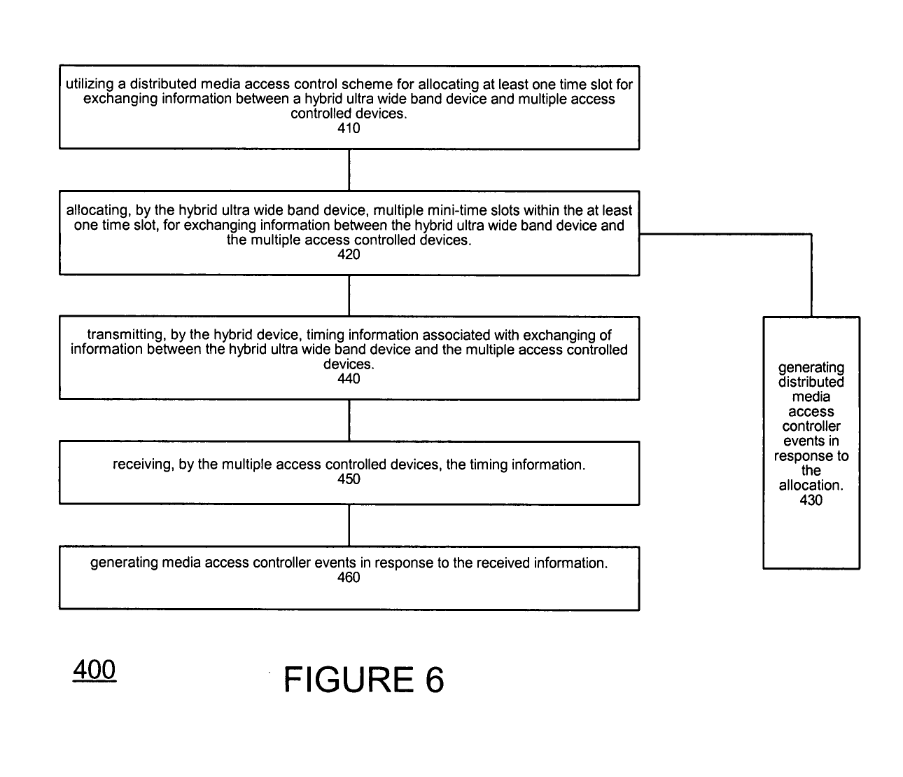

FIG. 6 is a flow chart of a method 400 for transmitting information, according to an embodiment of the invention.

Method 400 starts by stage 410 of utilizing a distributed media access control scheme for allocating at least one time slot for exchanging information between a hybrid ultra wide band device and multiple access controlled devices.

Stage 410 is followed by stage 420 of allocating, by the hybrid ultra wide band device, multiple mini-time slots within the at least one time slot, for exchanging information between the hybrid ultra wide band device and the multiple access controlled devices.

Conveniently, the hybrid ultra wide band device and peer devices that participate in the distributed media access scheme share a first clock and the hybrid ultra wide band device and the multiple access controlled device share another clock. Accordingly, stage 420 can include determining the time difference between the first and second clocks and adjusting a timing of distributed media access controller events in response to the difference.

Stage 420 is followed by stages 430 and 440. Stage 430 includes generating distributed media access controller events in response to the allocation. It is noted that these distributed media access controller events can include the transmission of stage 440, as well as multiple reception and transmission events that may occur during the exchange of information with the multiple access controlled devices. Conveniently, these events can also include reading multiple clock values, such as a MBOA clock value and a WUSB clock value and determining timing information in response to the difference between these clock values. It is noted that one of the distributed media access events can include a participation in stage 440.

Stage 440 includes transmitting, by the hybrid device, timing information associated with exchanging of information between the hybrid ultra wide band device and the multiple access controlled devices.

Stage 440 is followed by stage 450 of receiving, by the multiple access controlled devices, the timing information. Conveniently, the timing information includes a hybrid device time stamp and can also include a time difference between multiple time slots allocated for exchanging information between a hybrid ultra wide band device and multiple access controlled devices.

Stage 450 is followed by stage 460 of generating media access controller events in response to the received information. If, for example, an access controlled device includes a distributed media access controller then these events are distributed media access controller events.

Conveniently, stage 460 includes compensating for reception and processing delays of the access controlled device.

Conveniently, stage 460 includes defining a reception window, by an access controlled device, in response to a received time difference between consecutive time slots allocated for exchanging information between the hybrid ultra wide band device and the multiple access controlled devices.

Conveniently, stage 460 includes defining a reception window, by an access controlled device, in response to a relationship between time lapsed from a last time slot during which the access controlled device exchanged information with the hybrid ultra wide band device and between a time threshold.

It will be apparent to those skilled in the art that the disclosed subject matter may be modified in numerous ways and may assume many embodiments other then the preferred form specifically set out and described above. It is noted that each of the mentioned above circuitries can be applied by hardware, software, middleware or a combination of the above. The mentioned above methods can be stored in a computer readable medium, such as but not limited to tapes, disks, diskettes, compact discs, and other optical and/or magnetic medium.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim:

1. A method for transmitting information, the method comprises:
utilizing a distributed media access control scheme for allocating at least one time slot for exchanging information between a hybrid ultra wide band device and multiple access controlled devices;
allocating, by the hybrid ultra wide band device, multiple mini-time slots within the at least one time slot, for exchanging information between the hybrid ultra wide band device and the multiple access controlled devices; and
generating distributed media access controller events in response to the allocation.

2. The method according to claim 1 wherein the hybrid ultra wide band device and peer devices that participate in the distributed media access scheme share a first clock and the hybrid ultra wide band device and the multiple access controlled device share another clock.

3. The method according to claim 3 further comprising determining a time difference between the first and second clocks and adjusting a timing of distributed media access controller events in response to the difference.

4. The method according to claim 1 further comprising transmitting, by the hybrid device, timing information associated with exchanging of information between the hybrid ultra wide band device and the multiple access controlled devices.

5. The method according to claim 4 further comprising receiving, by the multiple access controlled devices, the timing information and generating media access controller events.

6. The method according to claim 5 wherein the generating of media access controller events by an access controlled device comprises compensating for reception and processing delays of the access controlled device.

7. The method according to claim 4 wherein the timing information comprises a hybrid device time stamp.

8. The method according to claim 4 wherein the timing information comprises a time difference between multiple time slots allocated for exchanging information between a hybrid ultra wide band device and multiple access controlled devices.

9. The method according to claim 7 further comprising defining a reception window, by an access controlled device, in response to a received time difference between consecutive time slots allocated for exchanging information between the hybrid ultra wide band device and the multiple access controlled devices.

10. The method according to claim 7 further comprising defining a reception window, by an access controlled device, in response to a relationship between time lapsed from a last time slot during which the access controlled device exchanged information with the hybrid ultra wide band device and between the specified time threshold.

11. A hybrid ultra wide band device comprising:
a distributed medium access controller adapted to participate in a distributed media access control scheme that allocates at least one time slot for exchanging information between a hybrid ultra wide band device and multiple access controlled devices; and
a second component, connected to the distributed media access component, adapted to allocate multiple mini-time slots within the at least one time slot, for exchanging information between the hybrid ultra wide band device and the multiple access controlled devices and to participate in a generation of distributed media access controller events in response to the allocation.

12. The device according to claim 11 wherein the distributed media access component of the hybrid device and peer devices that participate in the distributed media access scheme share a first clock and the second component utilizes another clock.

13. The device according to claim 12 wherein the second component is adapted to determine a time difference between the first and second clocks and to adjust timing information of distributed media access controller events in response to the difference.

14. The device according to claim 11 further comprising transmission circuitry adapted to transmit timing information associated with exchanging of information between the hybrid ultra wide band device and multiple access controlled devices.

15. The device according to claim 11 wherein the timing information comprises a hybrid device time stamp.

16. The device according to claim 11 wherein the timing information comprises a time difference between multiple time slots allocated for exchanging information between a hybrid ultra wide band device and multiple access controlled devices.

17. An access controlled device comprising:
a media access unit, adapted to time reception and transmission of information;
a second component, connected to the timing unit, adapted to receive timing information transmitted by a hybrid media access device; and to generate media access unit timing events in response to the timing information and to at least one delay associated with a reception of the timing information.

18. The device according to claim 17 further adapted to define a reception window in response to a received time difference between consecutive time slots allocated for exchanging information between the hybrid ultra wide band device and the multiple access controlled devices.

19. The device according to claim 17 further adapted to define a reception window in response to a relationship between time lapsed from a last time slot during which the access controlled device exchanged information with the hybrid ultra wide band device and between a time threshold.

20. A computer readable medium having code embodied therein for causing an electronic device to perform the stages of:
utilizing a distributed media access control scheme for allocating at least one time slot for exchanging information between a hybrid ultra wide band device and multiple access controlled devices;
allocating, by the hybrid ultra wide band device, multiple mini-time slots within the at least one time slot, for exchanging information between the hybrid ultra wide band device and the multiple access controlled devices; and
generating distributed media access controller events in response to the allocation.
